(19) United States
(12) Patent Application Publication
(10) Pub. No.: US 2026/0011487 A1
(43) Pub. Date: Jan. 8, 2026

(54) ELECTRONIC COMPONENT

(71) Applicant: TDK Corporation, Tokyo (JP)

(72) Inventors: Keigo HIGASHIDA, Tokyo (JP); Hironari GOSHIMA, Tokyo (JP)

(21) Appl. No.: 19/256,317

(22) Filed: Jul. 1, 2025

Related U.S. Application Data
(60) Provisional application No. 63/668,087, filed on Jul. 5, 2024.

(30) Foreign Application Priority Data
May 21, 2025 (JP) 2025-084840

(51) Int. Cl. H01F 27/34; H01F 27/28; H01F 27/30; H01F 27/32

(52) U.S. Cl. CPC H01F 27/34; H01F 27/306; H01F 27/324; H01F 27/2852

(57) ABSTRACT

Disclosed herein is an electronic component that includes first and second metal frames embedded in an element body having first and second surfaces. Each of the first and second metal frames includes: a first section; a second section; a third section connected between a first end of the first section and a third end of the second section; a fourth section connected to a second end of the first section; a fifth section connected to a fourth end of the second section; and a sixth section protruding form the third section. The sixth section of the first metal frame is sandwiched between the first and second sections of the second metal frame. The sixth section of the second metal frame is sandwiched between the first and second sections of the first metal frame.

### CROSS-REFERENCE TO RELATED APPLICATION

This application claims the benefit of US Provisional Patent Application No. 63/668,087, filed on July 5, 2024, and Japanese Patent Application No. 2025-084840, filed on May 21, 2025, the entire disclosures of which are incorporated by reference herein.

### BACKGROUND OF THE ART

The present disclosure relates to an electronic component and, more particularly, to an electronic component having a structure in which a metal frame is embedded in an element body.

### Description of Related Art

JP 2022-151206A discloses an electronic component having a structure in which a metal frame that has been subjected to bending is embedded in an element body.

The inductor disclosed in JP 2022-151206A is a surface- mount type electronic component.

### SUMMARY

The present disclosure describes an electronic component suitably being incorporated in a substrate for use.

An electronic component according to one aspect of the present disclosure includes: an element body having a first surface and a second surface opposite to the first surface in the first direction; and first and second metal frames embedded in the element body. Each of the first and second metal frames includes: a first section having a first end and a second end; a second section having a third end and a fourth end; a third section connected between the first end of the first section and the third end of the second section; a fourth section connected to the second end of the first section, a part of the fourth section being exposed on the first surface of the element body; a fifth section connected to the fourth end of the second section, a part of the fifth section being exposed on the first surface of the element body; and a sixth section protruding form the third section toward the first direction. The sixth section of the first metal frame is sandwiched between the first and second sections of the second metal frame in a second direction perpendicular to the first direction. The sixth section of the second metal frame is sandwiched between the first and second sections of the first metal frame in the second direction.

### BRIEF DESCRIPTION OF THE DRAWINGS

The above features and advantages of the present disclosure will be more apparent from the following description of some embodiments taken in conjunction with the accompanying drawings, in which:

FIGS. 1A and 1B are schematic transparent perspective views of an electronic component 100 according to an embodiment of the technology described herein as viewed in different directions;

FIGS. 2A and 2B are schematic perspective views for explaining the structure of the metal frame 110 as viewed in different directions;

FIGS. 3A and 3B are schematic perspective views for explaining the structure of the metal frame 120 as viewed in different directions;

FIG. 4 is a schematic cross-sectional view for illustrating an example in which an insulating member 141 is arranged between the section 111 of the metal frame 110 and the section 121 of the metal frame 120, and an insulating member 142 is arranged between the section 112 of the metal frame 110 and the section 122 of the metal frame 120;

FIG. 5A is a schematic cross-sectional view to explain an example in which the width W1 in the Y direction of the section 111 of the metal frame 110 is larger than the width W2 in the Y direction of the section 121 of the metal frame 120, and the width W3 in the Y direction of the section 112 of the metal frame 110 is larger than the width W4 in the Y direction of the section 122 of the metal frame 120; and

FIG. 5B is a schematic cross-sectional view to explain an example in which the width W1 in the Y direction of the section 111 of the metal frame 110 is larger than the width W2 in the Y direction of the section 121 of the metal frame 120, and the width W4 in the Y direction of the section 122 of the metal frame 120 is larger than the width W3 in the Y direction of the section 112 of the metal frame 110.

### DETAILED DESCRIPTION OF THE EMBODIMENTS

Some embodiments of the present disclosure will be explained below in detail with reference to the accompanying drawings.

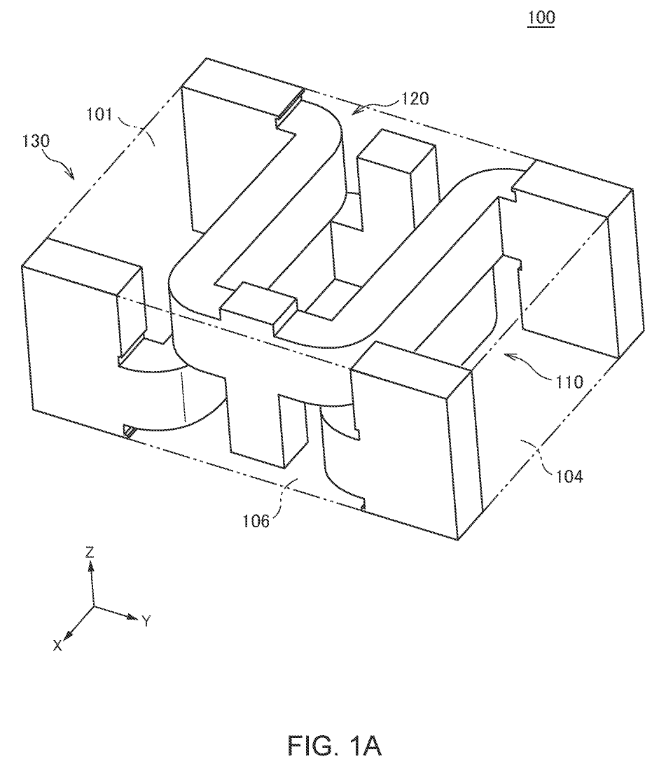

FIGS. 1A and 1B are schematic transparent perspective views of an electronic component 100 according to an embodiment of the technology described herein as viewed in different directions. Directional arrows indicating X-, Y-, and Z-axes are added in FIGS. 1A and 1B for descriptive convenience. In the following description, a direction indicated by each arrow is referred to as "positive direction", and the opposite direction thereof is referred to as "negative direction" (the same applies to other drawings). In the present disclosure, the Z-, Y-, and X- directions are sometimes referred to as first, second, and third directions, respectively. Further, a plane extending in the X- and Y-directions is sometimes referred to as "XY plane", a plane extending in the X- and Z-directions is sometimes referred to as "XZ plane", and a plane extending in the Y- and Z-directions is sometimes referred to as "YZ plane".

An electronic component 100 according to the present embodiment includes a magnetic element body 130 and metal frames 110 and 120 embedded in the magnetic element body 130.

The metal frames 110 and 120 are stacked one on the other in the Z-direction in the magnetic element body 130. A coil conductor composed of the metal frames 110 and 120 has a coil axis extending in the Z-direction. The magnetic element body 130 may be made of a composite magnetic material obtained by binding, with binder resin, a magnetic filler made of a high- permeability material such as ferrite or permalloy. The magnetic element body 130 has main surfaces 101 and 102 constituting the XY plane and positioned on mutually opposite sides, side surfaces 103 and 104 constituting the XZ plane and positioned on mutually opposite sides, and side surfaces 105 and 106 constituting the YZ plane and positioned on mutually opposite sides.

The metal frames 110 and 120 are made of metal such as copper (Cu) and function as a coil conductor. For example, the metal frames 110 and 120 may be obtained by punching a flat metal sheet, followed by bending. In this case, the thickness of each of the metal frames 110 and 120 is substantially constant in each part. Further, the metal frames 110 and 120 may each be a seamless integral metal member.

As described above, the electronic component 100 according to the present embodiment uses bulk metal frames 110 and 120 as coil conductors, so that a DC resistance is reduced as compared with when a coil conductor made of a plated film is used. Thus, the electronic component 100 according to the present embodiment can be used as an inductor for a power supply circuit. Further, the metal frames 110 and 120 are arranged in the Z-direction (coil axis direction), and thus a coil conductor constituted by the metal frame 110 and a coil conductor constituted by the metal frame 120 are coupled to each other.

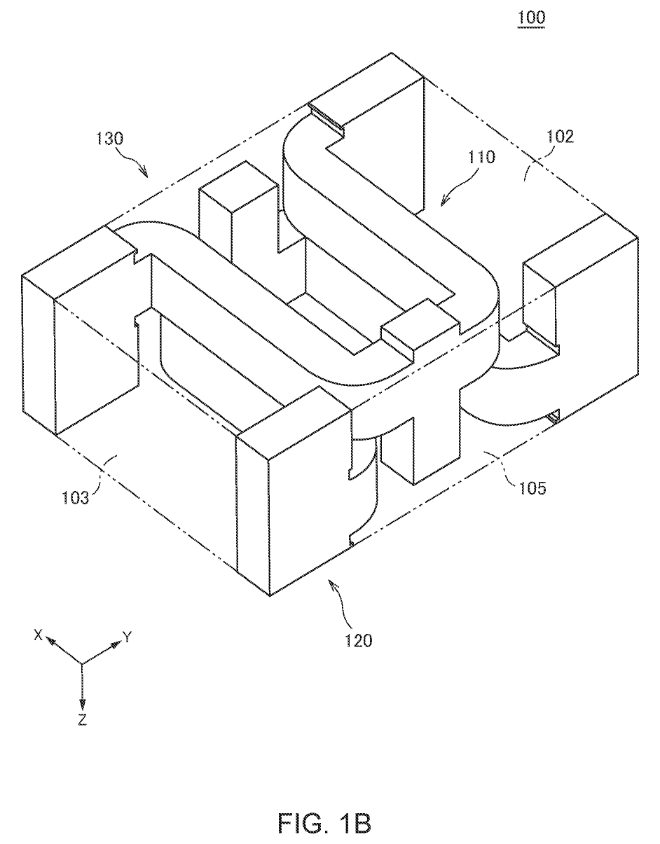

FIGS. 2A and 2B are schematic perspective views for explaining the structure of the metal frame 110 as viewed in different directions.

As illustrated in FIGS. 2A and 2B, the metal frame 110 has sections 111 to 117. The sections 111 and 112 extend in parallel to each other in the X-direction. The section 113 extends in the Y-direction and connects an end portion of the section 111 in the negative X-direction and an end portion of the section 112 in the negative X-direction. The section 114 is connected to an end portion of the section 111 in the positive X-direction. The section 115 is connected to an end portion of the section 112 in the positive X-direction. The section 116 protrudes from the section 113 in the positive Z-direction. The section 117 protrudes from the section 113 in the negative Z-direction. The length of the section 117 in the Z-direction may be shorter than the length of the section 116 in the Z-direction.

The XY surfaces of the sections 114 and 115 facing the positive Z-direction may be exposed from the main surface 101 of the magnetic element body 130. The XY surfaces of the sections 114 and 115 facing the negative Z-direction may be exposed from the main surface 102 of the magnetic element body 130. The YZ surfaces of the sections 114 and 115 facing the positive X-direction may be exposed from the side surface 106 of the magnetic element body 130. The XZ surface of the section 114 facing the negative Y-direction may be exposed from the side surface 103 of the magnetic element body 130.

The XZ surface of the section 115 facing the positive Y- direction may be exposed from the side surface 104 of the magnetic element body 130. The exposed surfaces of the section 114 constitute a first terminal electrode, and the exposed surfaces of the section 115 constitute a second electrode terminal.

The XY surface of the section 116 facing the positive Z-direction may be exposed from the main surface 101 of the magnetic element body 130. The XY surface of the section 117 facing the negative Z-direction may be exposed from the main surface 102 of the magnetic element body 130. The sections 111 to 113 may be embedded in the magnetic element body 130 without being exposed from the surfaces of the magnetic element body 130.

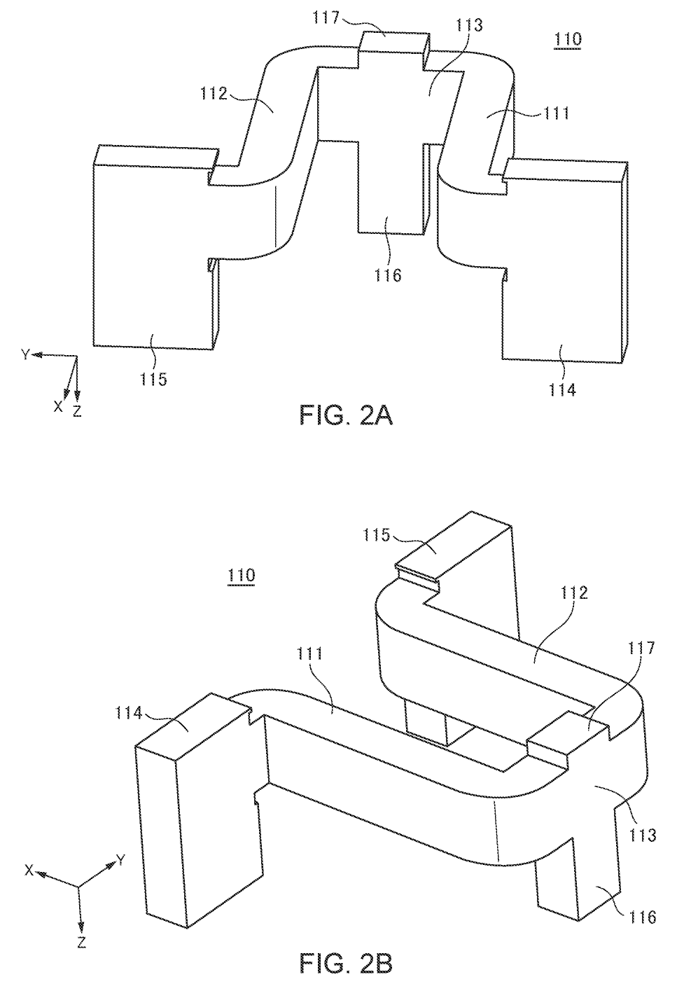

FIGS. 3A and 3B are schematic perspective views for explaining the structure of the metal frame 120 as viewed in different directions.

As illustrated in FIGS. 3A and 3B, the metal frame 120 has sections 121 to 127. The sections 121 and 122 extend in parallel to each other in the X-direction. The section 123 extends in the Y-direction and connects an end portion of the section 121 in the positive X-direction and an end portion of the section 122 in the positive X-direction. The section 124 is connected to an end portion of the section 121 in the negative X-direction. The section 125 is connected to an end portion of the section 122 in the negative X-direction. The section 126 protrudes from the section 123 in the negative Z-direction. The section 127 protrudes from the section 123 in the positive Z-direction. The length of the section 127 in the Z-direction may be shorter than the length of the section 126 in the Z-direction. The length of the section 126 in the Z-direction may be equal to the length of the section 116 in the Z-direction. The length of the section 127 in the Z-direction may be equal to the length of the section 117 in the Z-direction.

The XY surfaces of the sections 124 and 125 facing the positive Z-direction are exposed from the main surface 101 of the magnetic element body 130. The XY surfaces of the sections 124 and 125 facing the negative Z-direction may be exposed from the main surface 102 of the magnetic element body 130. The YZ surfaces of the sections 124 and 125 facing the negative X-direction may be exposed from the side surface 105 of the magnetic element body 130. The XZ surface of the ection 124 facing the negative Y-direction may be exposed from the side surface 103 of the magnetic element body 130. The XZ surface of the section 125 facing the positive Y- direction may be exposed from the side surface 104 of the magnetic element body 130. The exposed surfaces of the section 124 constitute a third terminal electrode, and the exposed surfaces of the section 125 constitute a fourth electrode terminal.

The XY surface of the section 126 facing the negative Z-direction may be exposed from the main surface 102 of the magnetic element body 130. The XY surface of the section 127 facing the positive Z-direction may be exposed from the main surface 101 of the magnetic element body 130. The sections 121 to 123 may be embedded in the magnetic element body 130 without being exposed from the surfaces of the magnetic element body 130.

The metal frames 110 and 120 may have the same structure.

In this case, the Z-direction length of the section 116 of the metal frame 110 and the Z-direction length of the section 126 of the metal frame 120 are equal to each other, and the Z-direction length of the section 117 of the metal frame 110 and the Z-direction length of the section 127 of the metal frame 120 are equal to each other.

The metal frames 110 and 120 having such a structure are put one on the other in the Z-direction inside the magnetic element body 130, as illustrated in FIGS. 1A and 1B.

Thus, when the section 114 of the metal frame 110 and the section 124 of the metal frame 120 are used as a pair of input terminals, and the section 115 of the metal frame 110 and the section 125 of the metal frame 120 are used as a pair of output terminals, magnetic flux generated by the coil conductor constituted by the metal frame 110 and the magnetic flux generated by the coil conductor constituted by the metal frame 120 cancel each other. The electronic component 100 according to the present embodiment is suitably being incorporated in a substrate for use. For example, in a state where the electronic component 100 according to the present embodiment is embedded in a substrate composed of a plurality of insulating layers stacked in the Z-direction, the first to fourth terminal electrodes exposed from the main surface 101 of the magnetic element body 130 can be connected with a wiring pattern provided in the substrate.

As illustrated in FIGS. 1A and 1B, the section 116 of the metal frame 110 are sandwiched by the sections 121 and 122 of the metal frame 120 in the Y-direction. Similarly, the section 126 of the metal frame 120 is sandwiched by the sections 111 and 112 of the metal frame 110 in the Y-direction.

When the sections 116 and 117 of the metal frame 110 are exposed respectively from the main surfaces 101 and 102 of the magnetic element body 130, the surfaces thereof may be used as heat radiation terminals. When the sections 126 and 127 of the metal frame 120 are exposed respectively from the main surfaces 102 and 101 of the magnetic element body 130, the surfaces thereof may be used as heat radiation terminals. A wiring pattern connected to the heat radiation terminal may be terminated without being connected to a power supply wiring or a signal wiring.

The surfaces of the sections 114 to 116 of the metal frame 110 that are exposed from the main surface 101 of the magnetic element body 130 may constitute the same plane. The surfaces of the sections 114,115, and 117 of the metal frame 110 that are exposed from the main surface 102 of the magnetic element body 130 may constitute the same plane. The surfaces of the sections 124 to 126 of the metal frame 120 that are exposed from the main surface 102 of the magnetic element body 130 may constitute the same plane. The surfaces of the sections 124, 125, and 127 of the metal frame 120 that are exposed from the main surface 101 of the magnetic element body 130 may constitute the same plane. The main surface 101 of the magnetic element body 130 may constitute the same plane with the surfaces of the sections 114 to 116 of the metal frame 110 that are exposed from the main surface 101 of the magnetic element body 130 and the surfaces of the sections 124, 125, and 127 of the metal frame 120 that are exposed from the main surface 101 of the magnetic element body 130. The main surface 102 of the magnetic element body 130 may constitute the same plane with the surfaces of the sections 114, 115, and 117 of the metal frame 110 that are exposed from the main surface 102 of the magnetic element body 130 and the surfaces of the sections 124 to 126 of the metal frame 120 that area exposed from the main surface 102 of the magnetic element body 130. This makes it easy for the electronic component 100 according to the present embodiment to be embedded in the substrate.

The electronic component 100 having the above configuration is manufactured as follows: in a state where the metal frame 110 is placed on a support such that the sections 114, 115, and 117 of the metal frame 110 contact the surface of the support, the metal frame 120 is put on the metal frame 110, and then the metal frames 110 and 120 are embedded in the magnetic element body 130. As a result, the metal frame 110 contacts the support surface at three points and can thus be stably supported on the support surface, thereby facilitating manufacture of the electronic component 100. In addition, when the surfaces of the sections 114, 115, and 117 exposed from the main surface 102 of the magnetic element body 130 constitute the same plane, the metal frame 110 can be placed more stably on the support.

The section 111 of the metal frame 110 and section 121 of the metal frame 120 may overlap each other in the Z- direction. The section 112 of the metal frame 110 and section 122 of the metal frame 120 may overlap each other in the Z- direction. The section 111 of the metal frame 110 and section 121 of the metal frame 120 may be electrically insulated from each other through the magnetic element body 130. The section 112 of the metal frame 110 and the section 122 of the metal frame 120 may be electrically insulated from each other through the magnetic element body 130.

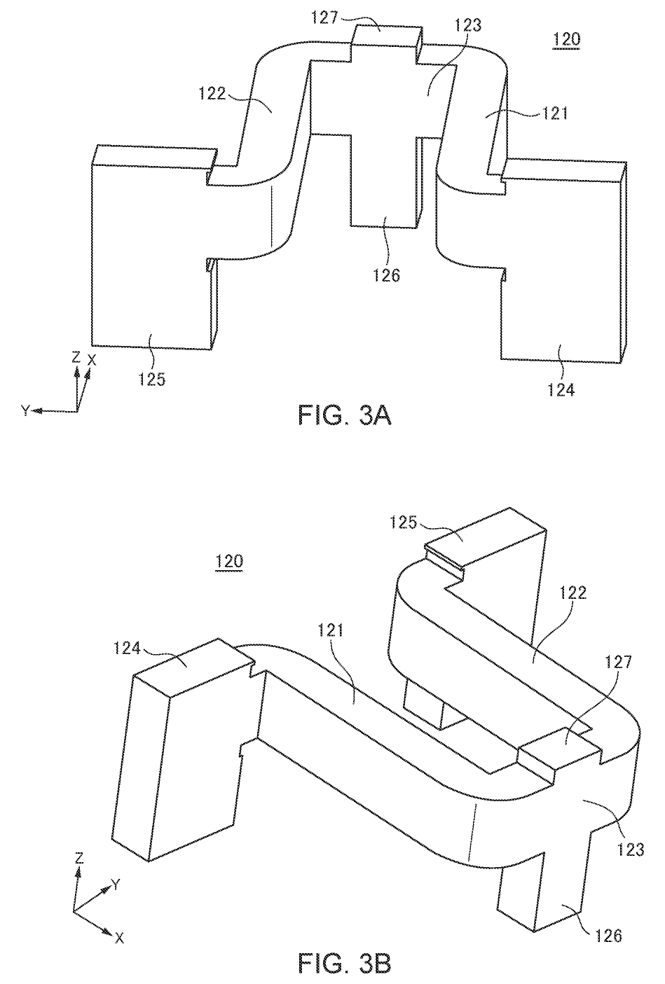

Alternatively, as illustrated in FIG. 4, an insulating member 141 may be disposed between the section 111 of the metal frame 110 and the section 121 of the metal frame 120, and an insulating member 142 may be disposed between the section 112 of the metal frame 110 and the section 122 of the metal frame 120. The insulating members 141 and 142 may each be a sheet-like or film-like resin, or a resin applied on the metal frame 110 or 120. Using a material having a permeability lower than that of the magnetic element body 130 for the insulating members 141 and 142 can reduce coupling between the coil conductor constituted by the metal frame 110 and the coil conductor constituted by the metal frame 120.

The section 111 of the metal frame 110 and the section 121 of the metal frame 120 may have the same width in the Y- direction. The section 112 of the metal frame 110 and the section 122 of the metal frame 120 may have the same width in the Y-direction.

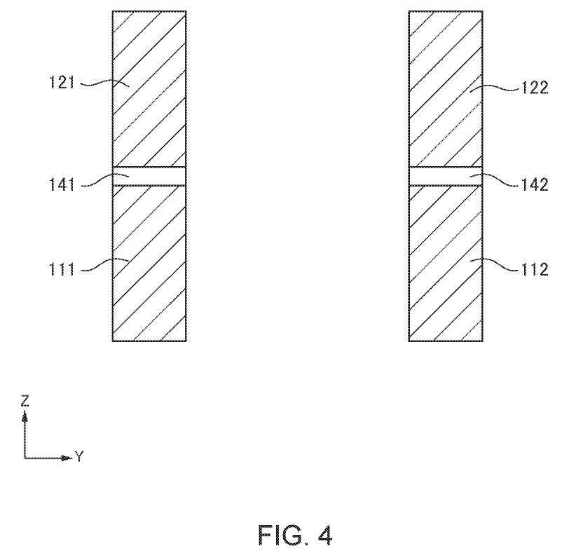

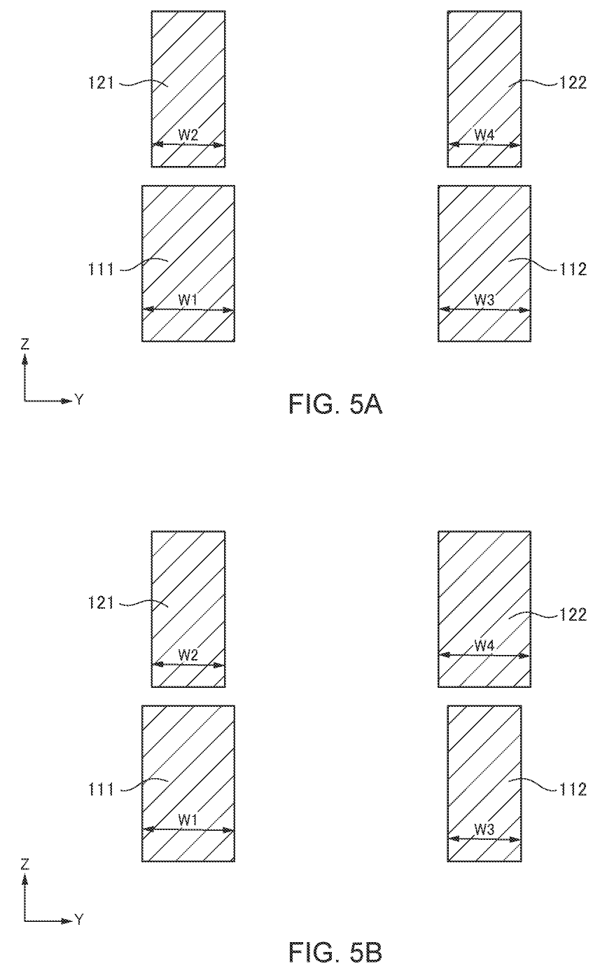

Alternatively, as in the example illustrated in FIG. 5A, a width W1 of the section 111 of the metal frame 110 in the Y-direction may be larger than a width W2 of the section 112 of the metal frame 120 in the Y-direction, and a width W3 of the section 112 of the metal frame 110 in the Y- direction may be larger than a width W4 of the section 122 of the metal frame 120 in the Y-direction. Thus, even when the position of the metal frame 120 with respect to the metal frame 110 is displaced in the Y-direction due to manufacturing variation, the overlapping width in the Z- direction between the section 111 of the metal frame 110 and the section 121 of the metal frame 120 can be constant, and the overlapping width in the Z-direction between the section 112 of the metal frame 110 and the section 122 of the metal frame 120 can be constant.

Further, as in the example illustrated in FIG. 5B, the width W1 of the section 111 of the metal frame 110 in the Y- direction may be larger than the width W2 of the section 112 of the metal frame 120 in the Y-direction, and the width W4 of the section 122 of the metal frame 120 in the Y-direction may be larger than the width W3 of the section 112 of the metal frame 110 in the Y-direction. This can reduce the difference in DC resistance between the metal frame 110 and metal frame 120.

While some embodiments of the technology according to the present disclosure have been described, the technology according to the present disclosure is not limited to the above embodiments, and various modifications may be made within the scope of the present disclosure, and all such modifications are included in the technology according to the present disclosure.

For example, although the metal frames 110 and 120 are embedded in the magnetic element body 130 in the electronic component 100 according to the above embodiment, they may be embedded in a non-magnetic element body.

The technology according to the present disclosure includes the following configuration examples, but not limited thereto.

An electronic component according to one aspect of the present disclosure includes: an element body having a first surface and a second surface opposite to the first surface in the first direction; and first and second metal frames embedded in the element body. Each of the first and second metal frames includes: a first section having a first end and a second end; a second section having a third end and a fourth end; a third section connected between the first end of the first section and the third end of the second section; a fourth section connected to the second end of the first section, a part of the fourth section being exposed on the first surface of the element body; a fifth section connected to the fourth end of the second section, a part of the fifth section being exposed on the first surface of the element body; and a sixth section protruding form the third section toward the first direction. The sixth section of the first metal frame is sandwiched between the first and second sections of the second metal frame in a second direction perpendicular to the first direction. The sixth section of the second metal frame is sandwiched between the first and second sections of the first metal frame in the second direction. This makes it possible to arrange the two metal frames one on top of the other in the first direction.

In the above electronic component, the sixth section of the first metal frame may be exposed on the first surface of the element body. According to this structure, the first metal frame comes into contact with the surface of the support at three points when the first metal frame is placed on a surface of the support during manufacture, making it possible to stably support the first metal frame on the surface of the support.

In the above electronic component, the fourth and fifth sections of each of the first and second metal frames may be exposed on the second surface of the element body. According to this structure, since the terminal electrodes are exposed from both the first surface and the second surface when this electronic component is embedded in a substrate, the degree of freedom increases in designing the substrate.

In the above electronic component, the sixth section of the second metal frame may be exposed on the second surface of the element body. This allows a surface of the sixth section of the second metal frame exposed from the second surface of the element body to be used as a terminal for heat dissipation.

In the above electronic component, the first metal frame may further include a seventh section protruding form the third section, and the seventh section of the first metal frame may be exposed on the second surface of the element body. This allows a surface of the seventh section of the first metal frame exposed from the second surface of the element body to be used as a terminal for heat dissipation.

In the above electronic component, the second metal frame may further include a seventh section protruding form the third section, and the seventh section of the second metal frame may be exposed on the first surface of the element body. This allows a surface of the seventh section of the second metal frame exposed from the first surface of the element body to be used as a terminal for heat dissipation.

In addition, when the second metal frame is placed on a surface of the support so that the second metal frame overlaps with the first metal frame during manufacture, the second metal frame contacts the surface of the support at three points, making it possible to stably support the second metal frame on the surface of the support.

In the above electronic component, the seventh section of each of the first and second metal frames may be shorter in length in the first direction than the sixth section of each of the first and second metal frames. This makes it possible to prevent interference between the first metal frame and the second metal frame in the first direction.

In the above electronic component, the sixth section of the first metal frame may be the same in length in the first direction as the sixth section of the second metal frame. This makes it easier to expose the sixth section of the first metal frame from the first surface of the element body, and the sixth section of the second metal frame from the second surface of the element body.

In the above electronic component, the seventh section of the first metal frame may be the same in length in the first direction as the seventh section of the second metal frame. This makes it easier to expose the seventh section of the first metal frame from the second surface of the element body, and the seventh section of the second metal frame from the first surface of the element body.

In the above electronic component, the first and second metal frames may be the same in structure as each other. This eliminates the need to separately fabricate the first metal frame and the second metal frame.

In the above electronic component, the first and second sections of the first metal frame may extend in parallel to each other in a third direction perpendicular to the first and second directions, and the first and second sections of the second metal frame may extend in parallel to each other in the third direction. As a result, the magnetic flux generated by the current flowing through the first section of the first metal frame and the magnetic flux generated by the current flowing through the second section of the first metal frame reinforce each other, and the magnetic flux generated by the current flowing through the first section of the second metal frame and the magnetic flux generated by the current flowing through the second section of the second metal frame reinforce each other.

In the above electronic component, the first section of the second metal frame may overlap with the first section of the first metal frame in the first direction, and the second section of the second metal frame may overlap with the second section of the first metal frame in the first direction.

This makes it possible to magnetically couple the first metal frame and the second metal frame.

The above electronic may further includes a first insulating film located between the first section of the first metal frame and the first section of the second metal frame, and a second insulating film located between the second section of the first metal frame and the second section of the second metal frame. This improves the insulation between the first metal frame and the second metal frame.

In the above electronic component, a first width of the first section of the first metal frame in the second direction may be different from a second width of the first section of the second metal frame in the second direction, and a third width of the second section of the first metal frame in the second direction may be different from a fourth width of the second section of the second metal frame in the second direction. This increases the degree of freedom in designing the first and second metal frames.

In the above electronic component, the first width may be greater than the second width, and the third width may be greater than the fourth width. This makes it possible to suppress changes in a magnetic coupling between the first metal frame and the second metal frame caused by manufacturing variations.

In the above electronic component, the first width may greater than the second width, and the fourth width may be greater than the third width. This makes it possible to reduce the difference in DC resistance between the first metal frame and the second metal frame.

What is claimed is:

1. An apparatus comprising:
an element body having a first surface and a second surface opposite to the first surface in the first direction; and
first and second metal frames embedded in the element body,
wherein each of the first and second metal frames includes:
a first section having a first end and a second end;
a second section having a third end and a fourth end;
a third section connected between the first end of the first section and the third end of the second section;
a fourth section connected to the second end of the first section, a part of the fourth section being exposed on the first surface of the element body;
a fifth section connected to the fourth end of the second section, a part of the fifth section being exposed on the first surface of the element body; and
a sixth section protruding form the third section toward the first direction,
wherein the sixth section of the first metal frame is sandwiched between the first and second sections of the second metal frame in a second direction perpendicular to the first direction, and
wherein the sixth section of the second metal frame is sandwiched between the first and second sections of the first metal frame in the second direction.

2. The apparatus of claim 1, wherein the sixth section of the first metal frame is exposed on the first surface of the element body.

3. The apparatus of claim 2, wherein the fourth and fifth sections of each of the first and second metal frames are exposed on the second surface of the element body.

4. The apparatus of claim 3, wherein the sixth section of the second metal frame is exposed on the second surface of the element body.

5. The apparatus of claim 4,
wherein the first metal frame further includes a seventh section protruding form the third section, and
wherein the seventh section of the first metal frame is exposed on the second surface of the element body.

6. The apparatus of claim 5,
wherein the second metal frame further includes a seventh section protruding form the third section, and
wherein the seventh section of the second metal frame is exposed on the first surface of the element body.

7. The apparatus of claim 6, wherein the seventh section of each of the first and second metal frames is shorter in length in the first direction than the sixth section of each of the first and second metal frames.

8. The apparatus of claim 7, wherein the sixth section of the first metal frame is the same in length in the first direction as the sixth section of the second metal frame.

9. The apparatus of claim 8, wherein the seventh section of the first metal frame is the same in length in the first direction as the seventh section of the second metal frame.

10. The apparatus of claim 9, wherein the first and second metal frames are the same in structure as each other.

11. The apparatus of claim 1,
wherein the first and second sections of the first metal frame extend in parallel to each other in a third direction perpendicular to the first and second directions, and
wherein the first and second sections of the second metal frame extend in parallel to each other in the third direction.

12. The apparatus of claim 11,
wherein the first section of the second metal frame overlaps with the first section of the first metal frame in the first direction, and
wherein the second section of the second metal frame overlaps with the second section of the first metal frame in the first direction.

13. The apparatus of claim 12, further comprising:
a first insulating film located between the first section of the first metal frame and the first section of the second metal frame; and
a second insulating film located between the second section of the first metal frame and the second section of the second metal frame.

14. The apparatus of claim 12,
wherein a first width of the first section of the first metal frame in the second direction is different from a second width of the first section of the second metal frame in the second direction, and wherein a third width of the second section of the first metal frame in the second direction is different from a fourth width of the second section of the second metal frame in the second direction.

15. The apparatus of claim 14,
wherein the first width is greater than the second width, and
wherein the third width is greater than the fourth width.

16. The apparatus of claim 14,
wherein the first width is greater than the second width, and wherein the fourth width is greater than the third width.
